(19) United States
(12) Patent Application Publication
(10) Pub. No.: US 2014/0279507 A1
(43) Pub. Date: Sep. 18, 2014

(54) CUSTOMER DRIVEN SECURITY SUITE

(71) Applicant: BANK OF AMERICA CORPORATION, Charlotte, NC (US)

(72) Inventors: Elbert Lee Whitler, Webster Groves, MO (US); Lisa Gibson, JR., Newnan, GA (US); Lianne G. Hebblewaite, Barrington, RI (US); Eileen D. Bridges, Fort Mill, SC (US)

(73) Assignee: BANK OF AMERICA CORPORATION, Charlotte, NC (US)

(21) Appl. No.: 13/826,722

(22) Filed: Mar. 14, 2013

(51) Int. Cl. G06Q 40/00

(52) U.S. Cl. CPC G06Q 40/00
USPC 705/44

(57) ABSTRACT

Systems and methods for providing a customer driven security suite are provided. The system may process a banking activity. The system may receive an account parameter from a customer. The system receive customer information corresponding to a banking activity. The system may determine whether the customer information is anomalous. The system may flag the banking activity with a first value if: (1) the information is anomalous and the account parameter overrides the anomalous information; or (2) the information is not anomalous and the account parameter does not override the information. The system may flag the banking activity with a second value if: (1) the information is not anomalous and the parameter is configured to prevent the activity when the parameter corresponds to the information, and the parameter corresponds to the information; or (2) the information is anomalous and the parameter does not override the anomalous information.

### FIELD OF TECHNOLOGY

Aspects of the disclosure relate to providing apparatus and methods for enhanced customization of a financial account. More specifically, the apparatus and methods may provide a customer driven security suite.

### BACKGROUND

Customers are increasingly mobile and rely on mobile devices for access to funds. While expecting increased accessibility and enhanced functionality, customers expect the highest level of security protection for their personal and financial information.

Current online banking tools offer some features to enhance protection of customer information. However, many such features are still primarily reactive in nature. Consequently, these features may impose limits on a customer's ability to customize account feature to individual lifestyles. Furthermore, a customer may often find that, by default, certain features are curtailed or blocked in the interest of assuming that such protection is warranted or even requested.

Typically a customer has limited capabilities to customize data security. This would include allowing a customer to enable certain functions or features. Further, a customer may wish to disable functions or features for specific access devices, locations or account types.

Online and Mobile Banking [and payments] are expected to continue to become increasingly popular methods of access to financial information. Secure and seamless delivery of these services is a key component of customer satisfaction. Development of a customer driven security suite presents an opportunity to deliver quality online and mobile access while providing security that builds trust and reduces fraud losses.

Typically, a customer may not customize security settings for account access tools, such as a smartphone or tablet. Furthermore, a customer is currently unable to seamlessly set transaction controls for banking activities.

It would be desirable, therefore, to develop customer driven security suite to deliver advanced functionality important to increasingly mobile customers, and improve fraud detection for unauthorized account access.

It is further desirable to allow a customer to customize account access in accordance with the customer's personal needs. Furthermore, it is desirable to concurrently minimize false positives associated with out-of-pattern transactions.

### SUMMARY OF THE INVENTION

It is an object of this invention to provide systems or methods for providing increased customization for a suite of banking activities. Systems or methods for providing increased customization for a suite of banking activities are therefore provided.

A system or method for setting account parameters is therefore provided. The account parameters may be customized to allow a customer to specify certain banking activities that should be prevented. In some embodiments, the account parameters may be customized to allow a customer to specify certain banking activities that should be executed, despite being an out-of-pattern transaction.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative arrangement in accordance with the principles of the invention;

FIGS. 2-6 show illustrative processes in accordance with the principles of the invention; and

FIGS. 7-10 show illustrative information in accordance with the principle of the invention.

### DETAILED DESCRIPTION

Apparatus and methods for processing a banking activity are provided. The apparatus may include, and the methods may involve, a receiver apparatus that is configured to receive an account parameter from a customer. The apparatus may receive customer information from a banking module. The customer information may correspond to a banking activity.

The apparatus may include, and the methods may involve, a processor apparatus that is configured to determine whether the customer information is anomalous. The processor apparatus may determine whether the customer information is anomalous based on anomalous activity detection information. The processor may flag the banking activity with a first value if: (1) the information is anomalous and the account parameter overrides the anomalous information; or (2) the information is not anomalous and the account parameter does not override the information. The processor may flag the banking activity with a second value if: (1) the information is not anomalous and the parameter is configured to prevent the activity when the parameter corresponds to the information, and the parameter corresponds to the information; or (2) the information is anomalous and the parameter does not override the anomalous information.

The account parameter may allow the customer to override certain banking activities that would otherwise be permitted. The parameter may allow the customer to override certain banking activities that would otherwise be denied. The customer may override the banking activity by inputting a customized parameter. The parameter may be customized by setting a range associated with a permitted or unpermitted activity.

The apparatus may include receiving an activity. The activity may include the banking activity. The banking activity may be a purchase. The banking activity may be a balance transfer. The banking activity may be a deposit. The banking activity may include checking a balance. The balance may be an account balance. The balance may an account balance of a checking account, savings account, money market account, retirement account, credit card account, charge card account, debit card account, or any other suitable account. The banking activity may be a withdrawal. The banking activity may be a transfer. The transfer may be a fund transfer. The transfer may be a wire transfer. The banking activity may be any suitable banking activity.

The information corresponding to the banking activity may include customer information. The customer information may include information about the customer that corresponds to the particular banking activity. The customer information may be reflected in a record. The record may be a data record. The record may be a record of the banking activity. The record may contain one or fields. The record may include a field descriptor. The record may include categories. The categories may be categories of parameters.

The apparatus may include an anomalous activity detector. The anomalous activity detector may produce an output. The output may be a report. The report may include fields. The fields of the anomalous activity detector report may correspond to the fields of the banking activity record.

The apparatus may include a customer profile record. The customer profile record may include fields. The fields of the customer profile record may correspond to the fields of the banking activity record. The fields of the customer profile record may be filled with parameters. The parameters may be received from the customer.

The receiver may be configured to receive information. The receiver may be configured to receive a parameter. The parameter may be the account parameter. The parameter may be a first parameter. The parameter may be a second parameter. The parameter may correspond to a limit. The limit may correspond to a field limit. The field limit may limit the permissible activity for a field. The field limit may limit the impermissible activity for a field. The field may be a field of the data record. The field may correspond to the data record from a customer banking activity. For example, the parameter may limit the allowed transaction amount for a single purchase to less than two hundred dollars. The parameter may correspond to a permission. For example, the parameter may permit execution of a banking activity in the state of New Jersey.

Illustrative examples of data record categories and fields are provided in Table 1, as listed below:

TABLE 1

| Illustrative Information | |
|---|---|
| Category | Illustrative Field |
| Temporal | Day |
| | Date |
| | Time |
| | Year |
| | Duration |
| | Seconds |
| | Minutes |
| | Hours |
| | Weeks |
| Geographic | Time zone |
| | Continent |
| | Country |
| | Province |
| | County |
| | State |
| | Postal Code |
| | Region |
| | House number |
| | Street |
| | Latitude |
| | Longitude |
| | Map coordinates |
| Merchandise | Merchant Category Code |
| | Merchant ID |
| | Merchant Name |
| | Merchandise Category |
| | Number of merchandise items |
| | SKU numbers |
| Amount | Minimum |
| | Maximum |
| | Prompt threshold |
| | Amount |
| | Available credit |
| | Currency |
| Instrument | Credit card A |
| | Credit card B |
| | Debit card A |
| | Debit card B |
| | Check |
| | Cash |
| | ACH transfer |
| | Electronic funds transfer |
| | ATM card |
| | Contactless chip |
| | Tablet |
| | Phone |
| | Mobile device |
| | Fixed device |
| Instrument Identifier | Transaction Network |
| | Loyalty/Rewards Network |
| | Issuer |
| | Brand |
| Venue | ATM |
| | Banking center |
| | Call center |
| | Wire instruction |
| | Online banking server |
| | Point-of-sale device |
| | Peer-to-peer |
| | Self-service kiosk |
| | In person |
| | Mobile device |
| Device Information | Identifier |
| | Model |
| | Brand |
| | Type |
| Access Information | Allow third party applications to |
| | access account |
| | Synchronize account with Calendar |
| | Synchronize account with partnered |
| | service |
| Account Ownership Information | View user name |
| | Reset password |
| | View contact e-mail address |
| | View security questions |
| | Change security questions |
| | Contact telephone number |
| | View signature card information |
| | View account number |
| | View address |
| Account Funds Information | View balance |
| | View past transaction |
| | View pending transaction |
| | View check image |
| | View check information |
| | View statement |
| | View by payee |
| | View by account |
| | View all past account activities |

Customer information may be anomalous. Anomalous customer information may correspond to a charge. For example, a credit charge for $6,000 in Moscow may be deemed anomalous for a customer who never spends more than $200 on a single charge, and has never traveled outside the state of California. Non-anomalous customer information may correspond to a charge. The charge may be pending. The charge may be a credit card charge. The parameter may permit execution of the credit card charge. The parameter may prevent execution of the credit card charge.

The apparatus may include receiving anomalous activity detection information. The anomalous activity detection information may correspond to any of the customer account information, as shown above in Table 1. The anomalous activity detection information may include prior banking activities. The anomalous activity detection information may include spending information. The spending information may include spending habits. The spending habits may include spending trends. The anomalous activity detection information may be based on historic behavior information associated with the customer.

The anomalous activity detection information may be processed by an anomalous activity detector. The anomalous activity detector may receive historic behavior information. The anomalous activity detector may identify banking activity as anomalous. The anomalous activity detector may classify banking activity as anomalous. The anomalous activity detector may classify banking activity as non-anomalous. The anomalous activity detector may identify banking activity as non-anomalous. The anomalous activity detector may produce an anomalous activity detector record. The record may be a report. The record may be a data output of the detector. The report may include anomalous activity detection information. The report may correspond to the customer information.

The apparatus may include a scoring device. The scoring device may assign a score. The score may be assigned based on the anomalous activity detection information. The score may be a weighted score. The weighted score may correspond to the parameter. The weighted score may determine whether the parameter is displayed on the anomalous activity detection information output. The weighted score may be a percentage assigned to the parameter's relevance. The relevance may be based on the parameter's relevance to the specific customer information that corresponds to the banking activity. The parameter's relevance may be a weighted score of a parameter's importance in a determination whether a banking activity is anomalous.

The banking activity may be flagged. The banking activity may be flagged with a value. The value may be assigned. The value may be the first value. The first value may trigger an instruction. The instruction may be an instruction to execute the activity. The instruction may be an instruction to complete the activity. The value may be the second value. The second value may trigger an instruction. The instruction may be an instruction to prevent the activity.

The second value may be configured to notify the customer of the banking activity. The second value may be configured to execute the banking activity and notify the customer of the banking activity.

The customer may customize the account. The account may be customized to allow all banking activities. The customized account may execute all banking activities flagged with the first value. The customized account may execute all banking activities flagged with the second value. The customized account may prevent all banking activities flagged with the second value. The prevented banking activities may also trigger a notification. The notification may be sent to the customer. The customer may be given the opportunity to override the prevention of the banking activity.

The customized account may allow the customer to select certain banking activities. The customer may select to receive a notification for a selection of banking activities. The customer may select to not receive a notification for a selection of banking activities. The banking activities for which the customer receives notifications may be flagged with the first value. The banking activities for which the customer receives notifications may be flagged with the second value.

The apparatus may be configured to receive information. The information may be customer information. The information may be received from the customer. The information may correspond to a device. The device may be an account access device. The account access device may be one of a set or a group of account access devices. The information received may be a list. The list may be received from the customer. The list may be a list of preapproved devices. The preapproved devices may be account access devices.

The apparatus may include the device. The device may be a first device. The device may be a second device. The device may be a first account access device. The device may be a second account access device.

The first parameter may be received from the first account access device. The first parameter may correspond to the first account access device. The second parameter may be received from the second account access device. The second parameter may correspond to the second account access device.

The first account access device may include customer information. The information may correspond to the activity. The parameter may override the customer information. The first parameter may override the customer information. The customer information may be anomalous information. The anomalous information may correspond to the activity. The customer information may be non-anomalous. The non-anomalous information may correspond to the activity. The second parameter may not override the customer information.

The processor may be configured to execute the banking activity. The activity may be executed in response to the information received. The processor may be configured to prevent the activity. The activity may be prevented in response to the information received.

The flagging of the banking activity with the first value may trigger an activity. The activity may be a prompt. The prompt may be for an additional security layer. The apparatus may receive an instruction. The instruction may be an instruction to prompt the customer to input additional information. The additional information may be additional security information. The additional security information may be the additional security layer. The prompt may be a prompt for a password. The prompt may be a request. The request may be a request to input the password. The password may be previously set. The previous setting of the password may be by the customer.

The flagging of the banking activity with the second value may prompt the customer to input additional security information. The prompt may be in response to a number of consecutive banking activities that have been blocked. The number may be set by the customer. The prompt may be in response to a number of attempted blocked banking activities within a certain time period. The time period may be set by the customer.

The receiver may receive input. The input may be received from the customer. The input may correspond to a customized account limitation. The input may be a first input. The input may be a second input. The first input and the second input may be in conflict. The presence of conflicting inputs may prevent the apparatus from determining which input will be the account parameter. The processor may apply a rule. The rule may be applied to the conflict. The rule may be a conflict resolution rule. The processor may apply the conflict resolution rule to select an input. The input may be the first input. The input may be the second input. The input may be selected as the account parameter.

The first input may correspond to the activity. The second input may correspond to the activity. The activity may be a permissible activity. The activity may be an impermissible activity. The first input may correspond to the permissible activity. The first input may correspond to the impermissible activity. The second input may correspond to the impermissible activity. The second input may correspond to the permissible activity.

The rule may require a selection. The selection may be of an input. The selection may be of the first input. The selection may be of the second input. The selection may be of the input that is ranked higher. The input may be ranked higher than another input.

FIG. 1 shows illustrative arrangement 100. Arrangement 100 may include banking module 101. Banking module 101 may be any suitable banking device. Banking module 101 may be a point-of-sale device, automated teller machine, mobile device, personal computing device, self-service kiosk, server computing device, hand-held or laptop device, or any other suitable device for processing a banking activity.

Banking module 101 may receive banking activity information 102. Banking activity information 102 may be a data record. Banking activity information 102 may include identifiers 104, 106, 108, and 110. Banking activity information 102 may correspond to banking activity.

Banking activity information 102 may include flag 112. Flag 112 may be associated with the banking activity. Flag 112 may include value 114 and value 116. Value 114 may be a unique value assigned to the banking activity. Value 114 may be an identifier that triggers an instruction. The instruction may be an instruction to execute the banking activity. Based on value 114, the banking activity may be executed.

Value 116 may be a unique value assigned to the banking activity. Value 116 may be an identifier that triggers an instruction. The instruction may be an instruction to prevent the banking activity. Based on value 116, the banking activity may be prevented.

Arrangement 100 may include anomalous activity detector 118. Anomalous activity detector 118 may detect the presence of anomalous activity. Anomalous activity detector 118 may receive banking activity information 102. Anomalous activity detector 118 may receive historic behavior information 120. Based upon the receiving of banking activity information 102 and historic behavior information 120, anomalous activity detector 118 may determine whether the banking activity is anomalous.

Anomalous activity detector 118 may output anomalous activity detector information 122. Information 122 may include identifiers 124, 126, 128, and 130. Each of identifiers 124, 126, 128 and 130 may have corresponding fields 132, 134, 136 and 138, respectively. Identifiers 124, 126, 128, and 130 may correspond to the identifiers 104, 106, 108 and 110.

Any of fields 132, 134, 136 and 138 may be assigned a value 140. Value 140 may be a weighted value. Value 140 may indicate that a threshold has been crossed. The threshold may be a threshold of anomalous information corresponding to the identifier. Value 140 may be a first unique numerical value. Value 142 may be a second unique numerical value. Each of value 140 and value 142 may correspond to a level of anomaly.

Arrangement 100 may include account parameters 150. Account parameters 150 may include identifiers 152 and 154. Account parameters 150 may correspond to the entirety of banking activity information 102. Account parameters 150 may correspond to a subset of banking activity information 102. Account parameters 150 may correspond to the entirety of anomalous activity detector information 122. Account parameters 150 may correspond to a subset of anomalous activity detector information 122.

Account parameters 150 may be input by the customer. The customer may input the account parameters using Graphical User Interface (“GUI”) 144. Account parameters 150 may be received using Application Programming Interface (“API”) 146. Database 148 may receive account parameters 150 from GUI 144. Database 148 may receive account parameters 150 from API 146.

Arrangement 100 may include processor 156. Processor 156 may determine whether account parameters 150 override anomalous activity detector information 122. If parameters 150 are determined to override anomalous activity detector information 122, processor 156 may assign flag 112 with associated value 114 to banking activity information 102. If parameters 150 are determined not to override anomalous activity detector information 122, processor 156 may assign flag 112 with associated value 116 to banking activity information 102.

Arrangement 100 may include processor 158. Processor 158 may determine whether account parameters 150 block the banking activity. If parameters 150 are determined to block the banking activity, processor 158 may assign flag 112 with associated value 116 to banking activity information 102. If parameters 150 are determined not to block the banking activity, processor 158 may assign flag 112 with associated value 114 to banking activity information 102.

FIG. 2 is a block diagram that illustrates a generic computing device 201 (alternatively referred to herein as a “server”) that may be used in accordance with the principles of the invention. Server 201 may be included in anomalous activity detector 118, processor 156, processor 158 (shown in FIG. 1) or in any other suitable apparatus that is shown or described herein. Server 201 may have a processor 203 for controlling overall operation of the server and its associated components, including RAM 205, ROM 207, input/output module 209, and memory 215.

Input/output (“I/O”) module 209 may include a microphone, keypad, touch screen, and/or stylus through which a user of device 201 may provide input, and may also include one or more of a speaker for providing audio output and a video display device for providing textual, audiovisual and/or graphical output. Software may be stored within memory 215 and/or storage to provide instructions to processor 203 for enabling server 201 to perform various functions. For example, memory 215 may store software used by server 201, such as an operating system 217, application programs 219, and an associated database 221. Alternatively, some or all of server 201 computer executable instructions may be embodied in hardware or firmware (not shown).

Server 201 may operate in a networked environment supporting connections to one or more remote computers, such as terminals 241 and 251. Terminals 241 and 251 may be personal computers or servers that include many or all of the elements described above relative to server 201. The network connections depicted in FIG. 2 include a local area network (LAN) 225 and a wide area network (WAN) 229, but may also include other networks. When used in a LAN networking environment, computer 201 is connected to LAN 225 through a network interface or adapter 223. When used in a WAN networking environment, server 201 may include a modem 227 or other means for establishing communications over WAN 229, such as Internet 231. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 219, which may be used by server 201, may include computer executable instructions for invoking user functionality related to communication, such as email, short message service (SMS), and voice input and speech recognition applications.

Computing device 201 and/or terminals 241 or 251 may also be mobile terminals including various other components, such as a battery, speaker, and antennas (not shown).

Terminal 251 and/or terminal 241 may be portable devices such as a laptop, cell phone, Blackberry™, or any other suitable device for storing, transmitting and/or transporting relevant information.

Any information described above in connection with database 221, and any other suitable information, may be stored in memory 215.

One or more of applications 219 may include one or more algorithms that may be used to process contingency funds information, transaction information or any other suitable type of information, and/or perform any other suitable tasks related to end-to-end self-service device analysis.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Processes in accordance with the principles of the invention may include one or more features of the processes illustrated in FIGS. 3-6. For the sake of illustration, the steps of the processes illustrated in FIG. 3-6 will be described as being performed by a “system.” The “system” may include one or more of the features of the apparatus that are shown in FIG. 2 and/or any other suitable device or approach. The “system” may be provided by an entity. The entity may be an individual, an organization or any other suitable entity.

Illustrative information that is exchanged with the system may be transmitted and displayed using any suitable mark-up language under any suitable protocol, such as those based on JAVA, COCOA, XML or any other suitable and languages or protocols.

FIG. 3 shows illustrative banking activity process 300 for processing a banking activity. One or more steps of the process, including step 302, may be executed by a user. The user may be a customer. The user may be a provider. The user may be any other suitable individual or entity. One or more steps of the process may be executed by a processor, such as processor 203 (shown in FIG. 2).

One or more steps of the process may be executed using an account access device. The account access device may be associated with GUI 144 (shown in FIG. 1). One or more steps of the process may be executed using banking module 101 (shown in FIG. 1). One or more steps of the process may be executed using anomalous activity detector 118. One or more steps of the process may be executed using processor 156. One or more steps of the process may be executed using processor 158.

At step 302, the system may receive an account parameter. The account parameter may be any suitable parameter. The system may receive the parameter from GUI 144, banking module 101, database 148, API 146, memory 215, processor 203, ram 205, or any other suitable apparatus or entity.

At step 304, the system may receive customer information from banking module 101. The customer information may correspond to the banking activity. The system may perform the banking activity using banking module 101.

At step 306, the system may receive anomalous activity detection information. The system may receive the anomalous activity detection information from anomalous activity detector 118. The anomalous activity detection information may correspond to output information. The information may be a list. The information may be a report. The information may report on anomalous activity for a field. The field may be a field of information corresponding to the banking activity.

Each of the fields may output information. The output may correspond to the detection of anomalous activity. All fields may include an output corresponding to anomalous activity detection information. A selection of fields may include an output corresponding to anomalous activity detection information. The selection may include all fields that cross a threshold. The threshold may be a threshold of anomaly.

At step 308, the system may determine whether the banking activity is anomalous. The system may determine whether the banking activity is anomalous based on anomalous activity detection information received in step 306. The determination of whether the banking activity is anomalous may be made using an algorithm. The determination of whether the banking activity is anomalous may be made by determining whether a threshold has been crossed.

At step 310, the system may flag the banking activity. The system may flag the banking activity with a first value.

At step 312, the system may flag the banking activity with the first value if the customer information corresponding to the banking activity is determined to be anomalous and the parameter overrides the anomalous information.

At step 314, the system may flag the banking activity with the first value if the customer information is determined not to be anomalous and the parameter does not block the banking activity.

At step 316, the system may determine that, based on the presence of the flag with the first value, the banking activity may be executed.

At step 318, the system may flag the banking activity. The system may flag the banking activity with a second value.

At step 320, the system may flag the banking activity with the second value if the customer information corresponding to the banking activity is not anomalous, the parameter is configured to block the banking activity when the parameter corresponds to the information and the parameter corresponds to the customer information.

At step 322, the system may flag the banking activity with the second value if the customer information is not anomalous and the parameter does not override the anomalous customer information.

At step 324, the system may determine that, based on the presence of the flag with the second value, the banking activity may be blocked.

FIG. 4 shows illustrative process 400 for receiving account parameters 150. At step 402, the system may receive one or more account parameters. The system may receive the account parameters from database 148. Database 148 may receive the account parameters from GUI 144. The system may receive the account parameters from API 146. Database 148 may receive the account parameters from API 146. The system may receive the account parameters from any other suitable apparatus or system.

At step 404, the system may receive a first account parameter. At step 406, the system may receive information corresponding to a first account access device. At step 407, the system may associate the first account parameter received in step 404 with the information corresponding to the first account access device. The system may configure the first account parameter as a parameter granting permissions to the first account access device. The system may configure the first account parameter as a parameter imposing restrictions on the first account access device.

At step 408, the system may receive anomalous information corresponding to a banking activity performed using the first account access device. The system may determine that the information determined to be anomalous may be anomalous as a result of the banking activity being performed utilizing the first account access device. The system may determine that the information determined to be anomalous may be the information corresponding to the device used to access the account. For example, the system may determine that accessing a bank account to make a wire transfer using a smartphone is anomalous. In a further example, the system may determine that accessing the same bank account to make a wire transfer using a tablet may be determined to be non-anomalous.

At step 412, the system may override the anomalous information corresponding to the banking activity performed on the first account access device. At step 414, based on the overriding in step 412, the system may execute the banking activity on the first account access device.

At step 416, the system may receive a second account parameter. At step 418, the system may receive information corresponding to a second account access device. At step 419, the system may associate the second account parameter received in step 416 with the second account access device. The system may configure the second account parameter as a parameter granting permissions to the second account access device. The system may configure the second account parameter as a parameter imposing restrictions on the second account access device.

At step 420, the system may receive anomalous information corresponding to a banking activity performed using the second account access device. The system may determine that the information is anomalous as a result of the banking activity being performed utilizing the second account access device. The system may determine that the information that is anomalous may be the information corresponding to the device used to access the account. For example, accessing a bank account to check an account balance using an ATM may be determined as anomalous. In a further example, accessing the same bank account to check an account balance using a fixed computer may be determined to be non-anomalous.

At step 424, the system may not override the anomalous information corresponding to the banking activity performed on the second account access device. At step 426, the system may prevent the banking activity from being executed on the second account access device, based on the determination in step 424 not to override the anomalous information.

FIG. 5. shows illustrative process 500 for receiving account parameter 150. At step 502, the system may receive one or more account parameters. The system may receive the account parameters from database 148. Database 148 may receive the account parameters from GUI 144. The system may receive the account parameters from API 146. Database 148 may receive the account parameters from API 146. The system may receive the account parameters from any other suitable apparatus or system.

At step 504, the system may receive a first account parameter. At step 506, the system may receive information corresponding to a first account access device. At step 507, the system may associate the first account parameter received in step 504 with the first account access device. The system may configure the first account parameter as a parameter granting permissions to the first account access device. The system may configure the first account parameter as a parameter imposing restrictions on the first account access device.

At step 508, the system may receive non-anomalous information corresponding to a banking activity performed using the first account access device. The system may determine that the information is non-anomalous as a result of the banking activity being performed utilizing the first account access device. The system may determine that the information determined to be non-anomalous may be the information corresponding to the device used to access the account. For example, accessing a bank account to make a payment using a smartphone may be determined as non-anomalous. In a further example, accessing the same bank account to make a payment using a tablet may be determined to be anomalous.

At step 512, the system may override the non-anomalous information corresponding to the banking activity performed on the first account access device. At step 514, based on the overriding in step 512, the system may block the banking activity from being executed on the first account device.

At step 516, the system may receive a second account parameter. At step 518, the system may receive information corresponding to a second account access device. At step 519, the system may associate the second account parameter received in step 516 with the second account access device. The system may configure the second account parameter as a parameter granting permissions to the second account access device. The system may configure the second account parameter as a parameter imposing restrictions on the second account access device.

At step 520, the system may receive non-anomalous information corresponding to a banking activity performed using the second account access device. The system may determine that the information is non-anomalous as a result of the banking activity being performed utilizing the second account access device. The system may determine that the information determined to be non-anomalous may be the information corresponding to the device used to access the account. For example, accessing a bank account to view all pending transactions using a fixed device may be determined as anomalous. In a further example, accessing the same bank account to view all pending transactions using a mobile device may be determined to be non-anomalous.

At step 524, the system may not override the non-anomalous information corresponding to the banking activity performed on the second account access device. At step 526, based on the determination in step 524 not to override the non-anomalous information, the system may execute the banking activity on the second account access device.

FIG. 6 shows illustrative process 600 for receiving an account parameter. At step 602, the system may receive customer authentication information. The system may receive the customer authentication information in the form of a login username and password.

At step 604, the system may receive a selection of customer account parameters. At step 606, the system may assign a set of unique parameters. The set of unique parameters may be assigned to one or more account access devices. At step 608, the system may assign one set of parameters to all account access devices associated with the account.

At step 610, when a banking activity is initiated, the system may determine if the parameters received in step 604 correspond to the transaction. At step 612, the system may determine whether the parameters from step 604 override the anomalous activity. At step 614, if the parameters received in step 604 override the anomalous activity, the system may execute the banking activity. At step 616, if the parameters received in step 604 do not override the anomalous activity, the system may prevent the banking activity.

At step 618, when a banking activity is initiated, the system may determine whether the parameters received in step 604 block the non-anomalous activity. At step 620, if the parameters received in step 604 block the non-anomalous activity, the system may prevent the banking activity. At step 622, if the parameters received in step 604 do not block the non-anomalous activity, the system may prevent the banking activity.

FIG. 7 shows matrix 700 for configuring account parameters. Matrix 700 may be a graphical user interface. The graphical user interface may be displayed to a customer. The customer may configure account parameters.

Matrix 700 may include display 702. Display 702 may display information about the account. Display 702 may display the name of the account. Display 702 may display the accounts associated with the configurable parameters displayed on matrix 700.

Matrix 700 may further include display 704. Display 704 may display the device or devices associated with the information corresponding to matrix 700. Button 705 may be a clickable button. Button 705 may allow the customer to choose a different account. The customer may associate the parameter settings from matrix 700 with the new account. The customer may assign new parameter settings to the new account.

Button 706 may be a clickable button. Button 706 may allow the customer to choose a new device. The new device may be associated with the same parameter settings as displayed on matrix 700. The new device may be assigned new parameter settings. The new device may be associated with the banking account as displayed on display 702. The new device may be associated with a new banking account.

Column 708 may display a list of fields. The fields may be a list of general selection categories. The fields may be categories of parameter fields. For example, a parameter may be a configured based upon a merchant, transaction amount, or specific payment type (debit card transactions). Columns 710, 712, 714, 716, 718, 720, 722 and 724 may display a list of fields. The fields may contain parameters. As the customer progresses along columns 710, 712, 714, 716, 718, 720, 722 and 724 the parameters may be narrowed and may modify the parameters in column 708.

For example, a customer may specify a parameter for a transaction column 708 as MCC (merchant category code). In column 710, the customer may choose to classify whether banking activities corresponding to the parameters from column 708 should be classified as permissible or impermissible. For example, the customer may determine that the information regarding MCC's in field set 744 may be configured as a permissible activity. In column 712, the customer may further narrow field set 744 by configuring a category to which the parameters from field set 744 should be applied. In column 714, the customer may further specify that the parameters in parameter field 744 may only correspond to banking activities that occur in a specific location. In column 716, the customer may further specify the transaction amount for field set 744. In column 718, the customer may specify the specific MCC that is permissible in field set 744. In column 720, the customer may specify the specific payment type. In column 722, the customer may specify the activity type. In column 724, the customer may specify the individual merchant. The customer may specify the merchant by merchant name. The customer may specify the merchant by merchant ID.

Matrix 700 may include parameter fields 726, 728, 730, 732 and 734. The parameter fields may define a set of parameters. The parameter fields may customize a set of parameters.

For example, parameter field 726 may define a set of parameters corresponding to a merchant category code as displayed in column 708. Column 710 may categorize this set of parameters as a set of parameters that specify a permissible activity. Parameter field 726 may define that all payments made by debit card for a transaction amount under $100, where the merchant category code is 5411, and where the transaction occurs in New York City, are permissible.

In a further example, parameter field 728 may define a set of parameters corresponding to a merchant. The customer may decide that certain merchant activities may be either permissible or impermissible. In parameter field 728, the customer may define that for all merchants falling within the category of liquor, all payments in all locations made with a credit card are impermissible.

It should be noted that parameter fields 726, 728, 730, 732 and 734 are merely examples of customizable parameter fields. Each of parameter fields 726, 728, 730, 732 and 734 are discrete parameter fields and may operate independently of one another. It should further be noted that any or all of columns 708, 710, 712, 714, 716, 718, 720, 722 and 724 need not be customized.

FIG. 8 shows illustrative graphical user interface 800 for displaying account settings to a customer. Interface 800 may be displayed after a customer clicks on button 706 (shown in FIG. 7). Interface 800 may be displayed as an account setting.

Banner 804 may display information corresponding to the devices already associated with the account. Column 806 may display the type of device. For example, boxes 810, 812 and 814 may correspond to a tablet, smartphone and PC, respectively. Column 808 may display a device identifier. The identifier may be a model name, a serial number, a device number, a phone number, an identifier customized by the customer or any other suitable identifier. Boxes 816, 818 and 820 may correspond to different account identifiers.

Button 822 may be a clickable button. Button 822 may allow the customer to register new devices. The devices may be configured to access the customer's account. The new devices may be customized with their own unique set of parameters. The new devices may be associated with parameters that have already been configured. The new devices may be configured with the same parameters as other devices.

FIG. 9 shows illustrative calendar 900. Calendar 900 may display a calendar that may be associated with a customer. Calendar 900 may be a stand-alone calendar. Calendar 900 may be linked to an e-mail account. Calendar 900 may be a series of calendars. Calendar 900 may be a work, personal, travel or any other suitable calendar, or a combination of those categories.

Tab 902 may display the calendar month. Button 906 may be a clickable button. Button 906 may allow the customer to synchronize the calendar with the account. When clicking on button 906, the customer may be prompted to input account access information. The customer may configure calendar 900 to synchronize with the account. The calendar synchronization may be customized by timeframe (i.e. every 10 seconds, every day, every month, or manual). The customer may not need to input account access information.

Button 908 may be a clickable button. Button 908, when clicked, may allow the customer to view other calendars. The other calendars may be associated with the account. Each of the calendars may have distinct customizable features. For example, a work calendar may be configured to synchronize with the customer's banking account every two minutes. In a further example, a personal calendar may be configured to synchronize with the bank account every week.

Tab 910 is an exemplary display of a customer calendar activity. Tab 910 may synchronize that information with the customer's banking account. For example, the customer's banking account may receive location information. The location information may then be set as a parameter. For example, the customer's banking account may have determined that a $400 purchase made in Paris, France is considered anomalous. The customer's information from tab 910 may be configured as an account parameter. The account parameter may then determine that, based on the information from tab 910, when the $400 purchase is made in Paris, France between March 4 and March 9, the anomalous activity should be overridden. The account may then allow the purchase to be executed.

The customer may customize tab 910. Tab 910 may be configured to turn off all parameters for specified dates. Tab 910 may be configured switch all parameters to a set of alternative parameters. The alternative parameters may be preset by the customer. For example, the customer may configure a field of travel parameters titled “Travel Parameters.” The travel parameters may be configured by the customer when the account is opened. The travel parameters may increase restrictions or permissions for certain parameter fields. For example, the field parameters may increase the limit for a single transaction and remove any restriction on location.

The customer may configure parameter fields for specific locations. For example, the customer may have preset parameters corresponding to Chicago, Ill. The customer account may be configured to substitute the parameter fields corresponding to Chicago for the dates when the customer calendar indicates the customer will be in Chicago. The customer account may be configured to substitute the parameter fields corresponding to Chicago when the customer is otherwise detected to be in Chicago. The detection may occur based on the information received from the account access device, mobile device location detection system, or any other method or device.

The customer account may be configured to prompt the customer when the customer is detected in a new location. The customer account may ask the customer to modify parameter settings. The customer account may require a password input to modify the parameter settings.

Tab 912 may be a further display of a customer calendar activity. Button 914 may be a clickable button. Button 914, when clicked may allow the customer to see other calendar dates.

FIG. 10 displays illustrative airline kiosk 1000. Airline kiosk 100 may contain graphical user interface 1002. Interface 1002 may contain information corresponding to an airline activity. Interface 1002 may be configured to synchronize with a banking account. The synchronization may be configured by the customer. The customer may configure the synchronization through the banking account graphical user interface. The customer may configure the synchronization the airline account graphical user interface. The bank and the airline may be involved in a partnership. The information may be received via an Application Programming Interface.

Tab 1006 may contain a name. The name may be the name of the airline passenger. The airline passenger may be the bank account customer. Tab 1008 may be an itinerary number. The itinerary number may correspond to an activity or group of activities. The itinerary number may be an airline itinerary.

Tab 1010 may include flight information. For example, tab 1010 may include information for one or more flights, such as tab 1020, illustrating Flight 1, or tab 1030, illustrating Flight 2. Tab 1010 may include dates 1012 and 1038. Dates 1012 and 1038 may correspond to the dates of Flight 1 and Flight 2. Tab 1010 may contain flight number 1014 and flight number 1036. Tab 1010 contains information on flight departures (headings 1018 and 1032) and flight arrivals (headings 1016 and 1034).

Interface 1002 may include additional options tab 1048. Tab 1048 may allow the customer to perform a variety of functions. For example, tab 1050 may allow the customer to synchronize the airline information with a partner company. The partner company may be a financial institution. The financial institution may use the synchronized information as account parameters. The information may be configured to synchronize automatically. The information may be configured to synchronize when the customer manually requests a synchronization of information using tab 1050.

The financial institution may use departure information 1018 and 1032, arrival information 1016 and 1034, and dates 1012 and 1028 to input location information as account parameters for the customer account. For example, as a result of the customer's itinerary 1008, the banking institution may be notified, and the parameters may be configured, that the customer will be in Paris from March 2 until March 15.

Tab 1052 may allow the customer to register a new account. The new account may be registered to synchronize with the airline information. Tab 1054 may allow the customer to customize the synchronization settings.

Thus, systems or methods for processing a banking activity are therefore provided. Persons skilled in the art will appreciate that the present invention can be practiced by other than the described embodiments, which are presented for purposes of illustration rather than of limitation, and that the present invention is limited only by the claims that follow.

What is claimed is:

1. Apparatus for processing a banking activity, the apparatus comprising:
receiver apparatus that is configured to receive:
from a customer, an account parameter; and,
from a banking module, customer information that corresponds to the banking activity;
from an activity detection module, anomalous activity detection information; and
processor apparatus that is configured to:
determine, based on the anomalous activity detection information, whether the customer information is anomalous;
flag the banking activity with a first value if:
(1) the information is anomalous and the parameter overrides the anomalous information; or
(2) the information is not anomalous and the parameter does not block the activity; and
flag the banking activity with a second value if:
(1) the information is not anomalous, the parameter is configured to block the activity when the parameter corresponds to the information, and the parameter corresponds to the information; or
(2) the information is anomalous and the parameter does not override the anomalous information.

2. The processor apparatus of claim 1 wherein the first value is configured to execute the banking activity and the second value is configured to block the banking activity.

3. The receiver apparatus of claim 1 further configured to receive from a customer information corresponding to an account access device.

4. The processor apparatus of claim 3 further configured to identify the account access device from a group of account access devices.

5. The receiver apparatus of claim 3 further configured to receive from a customer a preapproved list of account access devices.

6. The apparatus of claim 3 wherein the account access device is a first account access device and the parameter is a first parameter corresponding to the first account access device, the apparatus further comprising:
the receiver further configured to receive:
a second parameter from a second account access device, the second parameter corresponding to the second account access device;
wherein:
the first account access device and the second account access device comprise customer information corresponding to the banking activity; and
the first parameter overrides the anomalous information corresponding to the banking activity and the second parameter does not override the anomalous information corresponding to the banking activity.

7. The apparatus of claim 3 wherein the account access device is a first account access device and the parameter is a first parameter corresponding to the first account access device, the apparatus further comprising:
the receiver further configured to receive:
a second parameter corresponding to a second account access device; from the first account access device, non-anomalous customer information corresponding to the banking activity;
from the second account access device, non-anomalous customer information corresponding to the banking activity;
the processor further configured to:
execute the banking activity in response to the customer information received from the first account access device; and
prevent the banking activity in response to the customer information received from the second account access device.

8. The apparatus of claim 1, wherein when the banking activity is flagged with the first value, the receiver is further configured to receive an instruction to prompt the customer for input of an extra security layer.

9. The apparatus of claim 1 wherein, when the anomalous activity is a pending credit card charge, the parameter permits execution of the credit card charge.

10. The apparatus of claim 1 wherein, when the anomalous activity is a pending credit card charge, the parameter blocks execution of the credit card charge.

11. The apparatus of claim 1 wherein, when the non-anomalous activity is a pending credit card charge, the parameter blocks execution of the credit card charge.

12. The apparatus of claim 1 wherein, when the non-anomalous activity is a pending credit card charge, the parameter permits execution of the credit card charge.

13. A method for processing a banking activity, the method comprising:
receiving from a customer an account parameter;
receiving from a banking module customer information that corresponds to the banking activity;
receiving anomalous activity detection information;
determining, based on the anomalous activity detection information, whether the customer information is anomalous;
flagging the banking activity with a first value if:
the information is anomalous and the parameter overrides the anomalous information; or
the information is not anomalous and the parameter does not block the activity; and
flagging the banking activity with a second value if:
(1) the information is not anomalous;
the parameter is configured to block the activity when the parameter corresponds to the information; and
the parameter corresponds to the information; or
(2) the information is anomalous and the parameter does not override the anomalous information.

14. The method of claim 1 wherein the first value triggers an instruction to execute the banking activity and the value triggers an instruction to block the banking activity.

15. The method of claim 1 further comprising receiving from a customer information corresponding to an account access device.

16. The method of claim 15 further comprising identifying the account access device from a group of account access devices.

17. The method of claim 15 further comprising receiving from a customer a preapproved list of account access devices.

18. The method of claim 15 wherein the account access device is a first account access device and the parameter is a first parameter corresponding to the first account access device, the method further comprising:
receiving a second parameter from a second account access device, the second parameter corresponding to the second account access device;
wherein:
the first account access device and the second account access device comprise customer information corresponding to the banking activity; and
the first parameter overrides the anomalous information corresponding to the banking activity and the second parameter does not override the anomalous information corresponding to the banking activity.

19. The method of claim 15 wherein the account access device is a first account access device and the parameter is a first parameter corresponding to the first account access device, the method further comprising:
receiving a second parameter corresponding to a second account access device;
receiving from the first account access device non-anomalous customer information corresponding to the banking activity;
receiving from the second account access device non-anomalous customer information corresponding to the banking activity;
in response to the receiving from the first account access device, executing the banking activity; and
in response to the receiving from the second account access device, blocking the banking activity.

20. The method of claim 13 wherein, when the banking activity is flagged with the first value, the method further comprises a triggering of an additional security layer.

21. The method of claim 13 wherein, when the anomalous customer information corresponds to a pending credit card charge, the parameter permits execution of the credit card charge.

22. The method of claim 13 wherein, when the anomalous customer information corresponds to a pending credit card charge, the parameter blocks execution of the credit card charge.

23. The method of claim 13 wherein, when the non-anomalous customer information corresponds to a pending credit card charge, the parameter blocks execution of the credit card charge.

24. The method of claim 13 wherein, when the non-anomalous customer information corresponds to a pending credit card charge, the parameter permits execution of the credit card charge.

25. The method of claim 13 wherein the receiving comprises:
receiving a first input;
receiving a second input, the first input and the second input defining a conflict; and
applying a conflict resolution rule, whereby the account parameter is selected from the first input or the second input.

26. The method of claim 25 wherein the first input corresponds to a list of permissible activities and the second input corresponds to a list of impermissible activities.

27. The method of claim 25 wherein the rule requires selection of one of the first input and the second input that is ranked higher than another of the first input and the second input.

28. An article of manufacture comprising a non-transitory computer usable medium having computer readable program code embodied therein, the code when executed by a processor causes a computer to perform a banking activity, the computer readable program code in said article of manufacture comprising:
computer readable program code for causing the computer to receive:
from a customer an account parameter;
from a banking module customer information that corresponds to the banking activity; and
anomalous activity detection information;
computer readable program code for causing the computer to determine, based on the anomalous activity detection information, whether the customer information is anomalous;
computer readable program code for causing the computer to flag the banking activity with a first value if:
the information is anomalous and the parameter overrides the anomalous information; or
the information is not anomalous and the parameter does not block the activity; and
computer readable program code for causing the computer to flag the banking activity with a second value if:
(1) the information is not anomalous;
the parameter is configured to block the activity when the parameter corresponds to the information; and
the parameter corresponds to the information; or
(2) the information is anomalous and the parameter does not override the anomalous information.

29. The article of claim 28 further comprising computer readable program code for causing the computer to receive, from a customer, information corresponding to an account access device.

30. The article of claim 29 wherein, when the account access device is a first account access device and the parameter is a first parameter corresponding to the first account access device, the article further comprises:
computer readable program code for causing the computer to receive a second parameter from a second account access device, the second parameter corresponding to the second account access device;
wherein:
the first account access device and the second account access device comprise customer information corresponding to the banking activity; and
the first parameter overrides the anomalous information corresponding to the banking activity and the second parameter does not override the anomalous information corresponding to the banking activity.

31. The article of claim 29 wherein, when the account access device is a first account access device and the parameter is a first parameter corresponding to the first account access device, the article further comprises:
computer readable program code for causing the computer to receive:
a second parameter corresponding to a second account access device;
from the first account access device, non-anomalous customer information corresponding to the banking activity; and
from the second account access device, non-anomalous customer information corresponding to the banking activity;
computer readable program code for causing the computer to execute the banking activity in response to the receiving from the first account access device; and
computer readable program code for causing the computer to block the banking activity in response to the receiving from the second account access device.

32. The article of claim 28 further comprising:
computer readable program code for causing the computer to receive:
a first input; and
a second input, the first input and the second input defining a conflict; and
computer readable program code for causing the computer to apply a conflict resolution rule, whereby the account parameter is selected from the first input or the second input.

33. The article of claim 32 wherein the first input corresponds to a list of permissible activities and the second input corresponds to a list of impermissible activities.
